(19) United States
(12) Patent Application Publication
(10) Pub. No.: US 2008/0096747 A1
(43) Pub. Date: Apr. 24, 2008

(54) Oscillation-Dampened Roller

(76) Inventors: Mario Wipprecht, Konigsbronn (DE); Heinz Adam, Saarlouis (DE); Franz Freis, Ensheim (DE)

Correspondence Address: RATNERPRESTIA, P O BOX 980, VALLEY FORGE, PA, 19482-0980, US

(21) Appl. No.: 10/582,456

(22) PCT Filed: Oct. 8, 2004
(86) PCT No.: PCT/EP04/11298

§ 371 Date: Aug. 3, 2007

(30) Foreign Application Priority Data
Dec. 12, 2003 (DE) 103-58-292.4

(51) Int. Cl. D21G 1/02; D21G 1/00; F16C 13/00

(52) U.S. Cl. 492/4; 492/15

(57) ABSTRACT

A web processing roll comprising at least one cavity. The cavity of the roll is at least partially filled with a mixture of a liquid and at least one mixing partner that is insoluble in the liquid. Solid particles, preferably a granular solid, or another liquid constitute the mixing partner.

This application is the U.S. national phase application of PCT International Application No. PCT/EP2004/011298, filed Oct. 8, 2004, which claims priority to German Patent Application No. DE 103 58 292.4, filed Dec. 12, 2003.

### BACKGROUND OF THE INVENTION

1. Technical Field

The invention relates to a roller for a web-shaped medium, preferably for mechanically, thermally or thermo-mechanically treating a web-shaped medium.

The treatment can in particular be pressing, drying or smoothing the medium, or a combination of these types of processing. The medium is preferably a paper web.

2. Description of the Related Art

Such rollers are for example used in calenders, with which paper webs are smoothed. Calenders comprise a number of rollers which are mounted, such that they can rotate and move with respect to each other, in a frame supported on a foundation. The paper web to be treated is guided through between the rollers, wherein the rollers exert pressure on the paper web. The smoothing process is understood as impressing the smooth surface of the roller, at high pressure, onto the initially rough surface of the paper web. An increased temperature of the surface of the roller is advantageous, for which reason such rollers are in many applications heated.

Inevitable imperfections from the manufacture of the rollers, for example production tolerances at various stages of production, lead to imbalances and deformations of the rollers during operation. This becomes apparent in the form of oscillations and vibrations which are capable of significantly impairing operations. Once produced, the rollers are therefore balanced, i.e. the imbalances are measured and compensated for by suitable measures. In order to take thermal deformations into account, the rollers are also balanced at an increased temperature.

Tolerances also apply to the balancing, beyond which the cost of further improvement is no longer economical. Furthermore, the deformations during actual operation are also dependent on loads which cannot be completely simulated in a balancing machine. Rollers are also operated at different speeds and temperatures. The balancing itself, however, can only be optimized for a particular operational state. Residual imbalances, which lead to oscillations and vibrations during operation, therefore remain for the operational states deviating from this.

Calender rollers are therefore configured such that they are operated at a sufficient offset from their critical resonant frequencies. In the vicinity of the critical resonant frequencies, the oscillations and vibrations of the roller are amplified by resonance which is shared by the entire system of the calender, up until oscillation states which no longer permit the calender to be operated. This can be caused by markings on the paper web generated by rotational-frequency oscillations in the linear pressure, and can continue up until components of the calender are jeopardized by fatigue.

### SUMMARY OF THE INVENTION

It is an object of the invention to improve the oscillation characteristics of rollers for web-shaped media, in particular rollers for treating web-shaped media.

For machine tools, DE 100 46 868 C2 discloses filling the machine bed of a machine tool with a mixture having a pulpy consistency and consisting of a liquid and granular solids. This can effectively dampen oscillations which enter the machine bed during operation. The machine bed transfers the oscillations onto the liquid, which for its part tries to move the solid grains. Due to their mass inertia, however, the solid grains stay in place, and there is a relative movement between the liquid and the grains. Liquid friction on the grains and turbulence in the liquid itself dissipate energy, which dampens the oscillations in the machine bed and therefore the entire machine.

By analogy to this, a roller framework, for example a calender frame, which is embodied as a hollow construction, for example as a hollow welded construction, can also be fitted with a major dampening by filling the hollow spaces of the framework.

The invention, however, goes a decisive step further by filling a hollow space formed in the roller of a web-treating roller completely or partially with an energy-dissipating mixture. The web-processing roller can in particular be a calender roller. The roller can be used not only in paper machines but also for example in rotary printing machines or in processing metal or plastic films or strips.

The mixture consists of a liquid and at least one insoluble co-ingredient in the liquid, formed by solid particles, preferably a granular solid, or by another liquid. The mixture can include a number of different liquids. The mixture can also contain a number of different types of preferably granular solid, wherein the particles of the individual solids can differ in terms of size, shape and/or specific weight. In the mixture which in such cases is formed as a dispersion, the solid particles should however be uniformly and finely distributed, such that the mixture has a uniform mass distribution as viewed in the hollow space as a whole. The solid can in particular exhibit the consistency of sand. Although a dispersion is preferred, the mixture can in principle also be an emulsion consisting of at least two different liquids.

Preferred dispersions are disclosed in DE 100 46 868 C2, which is referenced in this respect.

The solid in preferred dispersions exhibits a shape, preferably with edges, which generates optimally high friction forces in the event of a relative movement of the solid in the liquid. If sand forms the solid, it is preferably crushed sand.

The mixture preferably has a pulpy consistency within the entire operating temperature range of the roller.

In preferred first embodiments, the at least one hollow space is a central hollow space, such that the rotational axis of the roller extends through the mixture. The hollow space is preferably concentric with the rotational axis. Rollers for mechanically or thermo-mechanically treating web-shaped media, as represented in particular by calender rollers, are predominantly fitted with a central hollow space. The embodiment of the hollow space can be design-related, as for example in so-called displacement rollers having a thermal treatment channel formed as an annular gap, or can be provided for the purpose of reducing operational stresses, as for example in rollers having thermal treatment channels formed as peripheral bores for conducting a heating fluid or cooling fluid. The roller shell itself can directly form a container wall for the mixture. The mixture can also be accommodated in a container provided specially for the mixture, and this container can be arranged in the interior of the roller. A number of such separate mixture containers can also be arranged in the interior of the roller, for example adjacently and spaced from each other along the rotational axis. The number of mixture containers can be rigidly or elastically supported in the interior of the roller.

In preferred second embodiments, the at least one hollow space is an annular gap which remains between the roller shell and a cylindrical body surrounded by the roller shell. The annular gap can be completely or partially filled with the mixture, wherein the roller shell forms an outer container wall for the mixture and the cylindrical body forms an inner container wall for the mixture. Furthermore, the hollow space can also be formed only within the cylindrical body. The cylindrical body can equally surround a central first hollow space, and a second hollow space can be formed in the annular gap. The two hollow spaces can each be completely or partially filled with the same mixture, or as appropriate also with different mixtures which however are each in their own right a mixture of the type described. As previously in the case of the at least one central hollow space, so also in these embodiments the roller shell or cylindrical body need not directly form a container wall for the mixture, although this is preferred.

While the at least one hollow space is preferably a hollow space which is concentric with the rotational axis of the roller, this is not however absolutely essential. Alternatively, a number of respectively non-concentric hollow spaces can also be provided, which however in their entirety should be arranged rotationally symmetrical about the rotational axis, in order not to cause imbalances for their part alone.

Filling the hollow space or number of hollow spaces has no effect on the balancing characteristics of the roller. It neither reduces the roller imbalance, nor can it for example influence a temperature-related bending of the roller which for its part again leads to an imbalance. On the contrary, filling the roller bore during an excursion of the mass of the roller would increase the centrifugal inertial forces as compared to a hollow space which is not filled. A dampening effect, such as caused by filling a roller framework which may be hollow, is also not to be expected. A little while after the roller has started up, the filling of the hollow space will rotate at the same frequency as the roller. Even in the event of a rotational-frequency central deviation—the predominant cause of roller imbalance at high speeds—there would be no relative movement between the roller and the mixture which could ultimately have a dampening effect. This has also been confirmed by practical experiments. The imbalance of a roller tube is not changed by filling the interior of the tube with the mixture, which is preferably provided as a pulpy dispersion.

The so-called smooth running of a roller filled with the mixture, as compared to a roller without any filling, as the critical resonant frequency is approached or even exceeded, is by contrast remarkable. When the roller was not filled, the speed of the balancing machine had to be curbed because it was in danger of jumping off the rolls, while after the hollow space of the roller had been filled, it was possible to pass the critical speed without any problems. The roller even ran smoothly in the so-called super-critical range.

In retrospect, theory also provides a plausible explanation for this: as long as the roller and its filling rotate with each other in the sub-critical range without moving relative to each other, additional dampening is not possible. As the resonant frequency is approached, however, there is a phase shift in real systems—which constantly exhibit an elasticity and dampening. The excursion caused by the imbalance force remains short of the imbalance force by an increasing rotational angle, until a stable phase shift of 180° is achieved above the resonant frequency. However, as soon as the imbalance force—or the centrifugal force due to the imbalance—deviates from the direction of the excursion, currents form in the filling, i.e. in the mixture, which have a dampening effect. Filling the at least one hollow space in accordance with the invention thus affords the option of manufacturing cost-effective rollers which can be operated near their resonant frequency and even in the super-critical range. Due to the invention, the rollers can be embodied with smaller diameters. Furthermore, not only can the rollers in a calender be embodied to be smaller, lighter and more cost-effective at an unchanged calender width, but the entire calender can also thus be dimensioned to be smaller.

An additional positive effect is that a roller in accordance with the invention is also capable of effectively dampening oscillations and vibrations generated by other components with which the roller cooperates in treating the web, for example one or more companion rollers, by drives, bearings, etc. or also by the web-shaped medium itself. Thus, for example, a significant improvement can also be expected with regard to the occurrence of barring, as is a fear with calenders.

Lastly, even in the range of the so-called semi-critical speed, a roller in accordance with the invention also exhibits greater smooth running than a roller which is identical in design but has no filling. Semi-critical resonances occur when there is anisotropy in the roller cross-section. Such a roller then has different rigidities in two planes perpendicular to each other. If such a roller, mounted in its two trunnions and under its own weight or an additional linear load, is rotated once about its axis, the magnitude of its sagging passes through two periods. Such a roller experiences a stimulation twice at a rotational speed corresponding to half its resonant frequency, i.e. at this speed, it is stimulated at a frequency corresponding to its resonant frequency. Given this stimulation, the dampening by the filling becomes fully effective.

In preferred embodiments, the mixture can be charged with a pressure burden, preferably by means of a chamber which can be or is already expanded by a hydraulic fluid. The chamber is preferably arranged within the mixture, but can in principle also form an outer wall of a hollow space which in this case is as a whole variable in its volume. The walls of the chamber are flexible, as a whole or in areas. In the latter case, the chamber is formed by a bubble. The chamber can however also be formed only from rigid chamber walls, at least one of which can move with respect to at least one other container wall and so vary the enclosed volume. Such a chamber can in particular be formed in the manner of a piston-cylinder arrangement, wherein a chamber wall forming the piston is preferably linearly guided by the surrounding chamber wall. A combination of flexible and moving, rigid chamber walls is also advantageous. The chamber can in particular be formed by means of an elastic restoring means, in particular bellows, preferably metal bellows. The moving container wall cited can be fastened to a top end of the bellows or can be formed directly by the top end, while the bottom end of the bellows is connected to another container wall. The pressure force of the enclosed fluid and the elasticity force of the bellows advantageously superimpose each other positively, such that if the mixture expands in volume, the volume of the chamber is reduced and the chamber pressure and also the restoring elasticity force of the bellows are thus increased. The chamber can advantageously compensate for changes in the volume of the hollow space and/or the mixture situated in it and can thus act as an equalizing chamber. Changes in volume even occur solely due to changes in the temperature of the roller.

Instead of pressurizing it by means of one or more chambers, the mixture can in principle also be directly placed under a pressure burden by charging it with hydraulic fluid. The hydraulic fluid can be a gas or gas mixture, in particular air, or can also be an additional liquid. In an alternative, likewise preferred embodiment, the hollow space can be evacuated, i.e. the mixture contained in it can be charged with a partial vacuum.

### BRIEF DESCRIPTION OF THE DRAWINGS

Example embodiments of the invention are explained below by way of figures. Features disclosed by the example embodiments, each individually and in any combination of features, advantageously develop the subjects of the claims and also the embodiments described above. There is shown:

FIG. 1 a roller in a first example embodiment, comprising a roller shell filled with an oscillation-dampening mass in which an equalizing chamber is arranged;

FIG. 2 a roller in a second example embodiment, comprising a roller shell filled with the mass and a modified equalizing chamber arranged in the mass;

FIG. 3 a roller in a third example embodiment, comprising at least one dampening body arranged in the roller shell;

FIG. 4 a roller in a fourth example embodiment, comprising a double-walled roller body in which the annular gap is filled with the oscillation-dampening mass;

FIG. 5 a roller in a fifth example embodiment, comprising a roller shell and a hollow displacement body elastically supported in it;

FIG. 6 a roller in a sixth example embodiment, comprising a roller shell and a solid displacement body elastically supported in it;

FIG. 7 a roller in a seventh example embodiment, comprising a roller shell and a displacement body fixedly supported in it and filled with the mass; and

FIG. 8 a roller in an eighth example embodiment, comprising a roller shell and a displacement body fixedly supported in it and filled with the mass, wherein an annular gap remaining between the roller shell and the displacement body is also filled with the mass.

### DETAILED DESCRIPTION

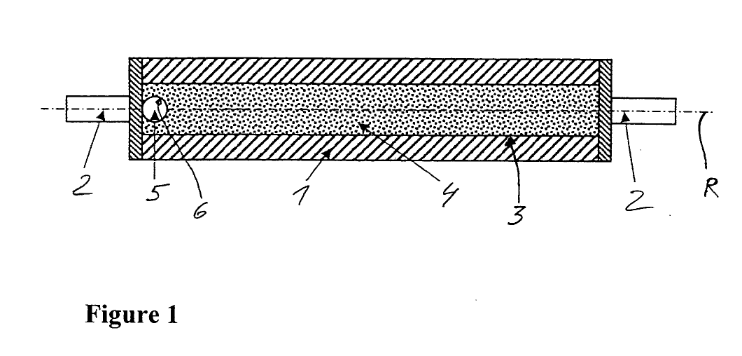

FIG. 1 shows a roller in a first example embodiment, comprising a circular cylindrical roller shell 1 to which a trunnion 2 is fastened via a trunnion flange at each of its two axial ends. The roller thus obtained can be mounted on its two trunnions 2 such that it can be rotated and driven about a rotational axis R. The roller can in particular be a calender roller for smoothing a paper web.

In the roller shell 1, which is rotationally symmetrical with respect to the rotational axis R, a central hollow space 3 is formed which is likewise rotationally symmetrical with respect to the rotational axis R. On its peripheral side, the shell inner surface of the roller shell 1 forms the wall of the hollow space. The two trunnion flanges seal the hollow space 3 at the two axial front sides of the roller shell 1.

The hollow space is filled with a mixture 4 consisting of a liquid and a multitude of solid particles. The solid particles are granular. The mixture 4 as a whole exhibits a pulpy consistency. The mixture 4 completely fills the hollow space 3, except for a chamber 5 filled with a gas. A flexible membrane 6 forms the wall of the chamber 5. The membrane 6 is preferably elastic. The chamber 5 is thus formed as a bubble, preferably an elastic bubble. The chamber 5 is filled with air, wherein the air pressure in the chamber 5 is greater than the pressure in the surrounding roller. The chamber 5 and thus the whole of the mixture 4 are therefore under a pressure burden. The chamber 5 acts as an equalizing chamber by equalizing changes in volume which the hollow space 3 and the mixture 4 experience relative to each other.

The roller shell 1 is shown as a simple tube. If the roller 1, 2 is a roller for thermo-mechanically treating a web, then the roller shell 1 can be thermally treated, i.e. heated or cooled. The roller 1, 2 can for example comprise peripheral thermal treatment channels which extend axially through the roller shell 1 and preferably port at both axial ends. As a displacement roller, it could comprise an annular gap surrounding the rotational axis R as a thermal treatment channel formed between the roller shell 1 and a displacement body arranged in it. The displacement body can directly envelop the hollow space with the mixture 4, such as the roller shell 1 in the example shown.

FIG. 2 shows a second example embodiment of an oscillation-dampened roller 1, 2, which only differs from the roller 1, 2 of the first example embodiment with respect to the equalizing chamber. The equalizing chamber 7 of the second example embodiment includes a rigid chamber wall 8, a disc-shaped chamber wall 9 and elastic pleated bellows 10. The pleated bellows 10 are metal spring bellows. The chamber wall 8 surrounds the chamber wall 9 and forms a linear guide along the rotational axis R for the chamber wall 9. Furthermore, it also surrounds the pleated bellows 10. The chamber wall 8 is cup-shaped with a preferably circular cylindrical base and a completely encircling side wall which projects from the base, parallel to the rotational axis R, and guides the chamber wall 9. The chamber wall 8 is fastened to one of the trunnion flanges; in the example embodiment, its base is placed onto the flange. The equalizing chamber and the components 8 to 10 forming it preferably exhibit rotational symmetry about the rotational axis R. The bottom end of the pleated bellows 10 is fastened to the cup rim of the chamber wall 8 and thence protrudes into the cup formed by the chamber wall 8. The chamber wall 9 is fastened to the top end of the bellows 10. The chamber wall 8 and the chamber wall 9 together form a piston-cylinder arrangement. The main part of the chamber 7 is formed by the hollow space between the chamber wall 9 and the opposing base of the chamber wall 8 along the rotational axis R. Behind the chamber wall 9, as viewed from the base of the chamber wall 8, a secondary chamber remains between the chamber wall 8 and the pleated bellows 10. The chamber 7 and the secondary chamber are preferably connected to each other, such that pressure equalization can occur. The chamber 7 is sealed off from the mixture 4 by fastening the pleated bellows 10 circumferentially fluid-proof to the chamber wall 8. An expansion of the pleated bellows 10 is counteracted on the one hand by their restoring elasticity force and on the other by the associated increase in pressure in the chamber 7, which can equalize changes in volume which the hollow space 3 and the mixture 4 can experience relative to each other.

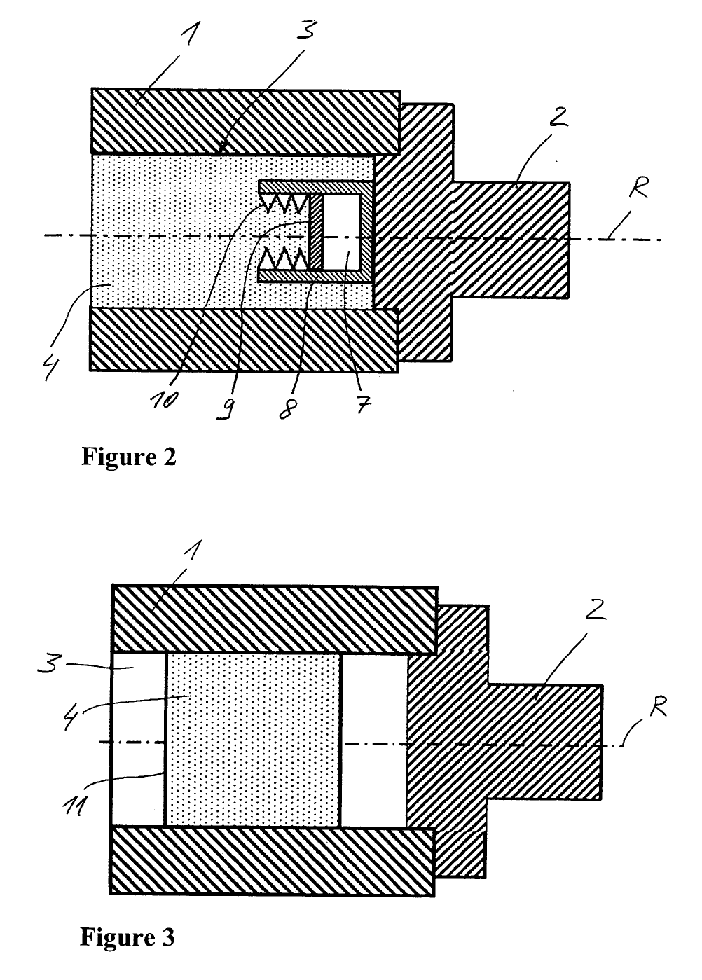

FIG. 3 shows a roller 1, 2 in a third example embodiment in which the roller shell 1 does not directly form the container wall of the mixture 4, as in the first and second example embodiment, but rather a dampening body is arranged in the central hollow space 3 of the roller. The dampening body is formed by a container 11 and the mixture 4 which completely fills the container 11. The container 11 is a circular cylindrical container in which the cylindrical shell sits solidly on the roller shell 1 and is rigidly fastened directly to the shell inner surface of the roller shell 1, preferably in a non-positive lock. The circular cylindrical container 11 comprises walls which are thin in comparison to its diameter and length. The cross-section of the hollow space enclosed by the container 11 therefore substantially corresponds to the cross-section of the hollow space 3 of the roller. The axial length of the hollow space 3 of the roller, measured in the direction of the rotational axis R, is however significantly greater than the axial length of the hollow space of the dampening body 4, 11 filled with the mixture 4. Preferably, a number of the dampening bodies 4, 11 are arranged in the hollow space 3 of the roller, spaced from each other along the rotational axis R, and supported on the roller shell 1. By arranging the mixture 4 axially in sections, as may be realized using the dampening body 4, 11 or number of dampening bodies 4, 11, the oscillation characteristics of rollers can be influenced particularly specifically, and individually for each roller. Separate dampening bodies 4, 11 are also particularly suitable for retrofitting rollers which were not originally provided with such oscillation dampening. In one modification, the shell of the container 11 could be replaced by the roller shell 1 by only inserting the disc-shaped bases of the container 11 into the roller shell 1, as front walls.

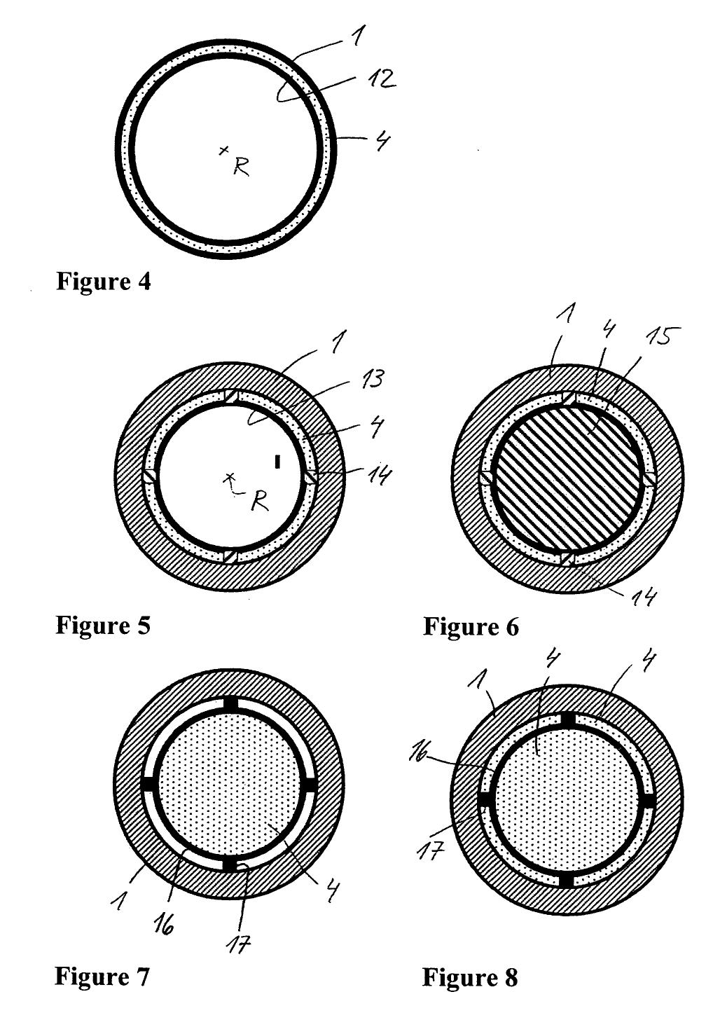

FIG. 4 shows a fourth example embodiment of an oscillation-dampened roller, in cross-section. The roller includes a double-walled roller body consisting of a thin outer roller shell 1 and a thin inner hollow cylindrical body 12. The roller shell 1 and the cylindrical body 12 are fixedly connected to each other via the two trunnion flanges which correspond to the trunnion flanges 2 of the other example embodiments. The roller shell 1 and the cylindrical body 12 can also be connected to each other in other connecting points over the axial length, but this is not absolutely essential.

The annular gap is completely filled with the mixture 4. The roller shell 1 and the cylindrical body 12 thus form, directly and in conjunction with the two trunnion flanges, the container walls of the hollow space filled with the mixture.

In a fifth example embodiment, FIG. 5 shows a displacement roller in cross-section. The roller comprises a roller shell 1 and a cylindrical body 13 formed as a displacer which is arranged within the roller shell 1 and elastically supported on and fastened to the roller shell 1 by means of elastic support bodies 14. The roller shell 1 can be formed with peripheral thermal treatment channels, as in the first, second and third example embodiment. The hollow space formed by the annular gap between the roller shell 1 and the cylindrical body 13 is completely filled with the mixture 4, as in the fourth example embodiment.

FIG. 6 shows a roller in a sixth example embodiment which differs from the fifth example embodiment only in that the cylindrical body 15 is not a hollow cylinder but a solid cylinder.

FIG. 7 shows a roller in a seventh example embodiment, comprising a roller shell 1 and a hollow cylindrical body 16 arranged in the roller shell 1. The cylindrical body 16 is filled with the mixture 4, i.e. it forms its container wall on the peripheral side. The annular gap between the roller shell 1 and the cylindrical body 16 remains free and a thermal treatment fluid can for example flow through it, as is known from displacement rollers. The cylindrical body 16 is centrically arranged in the interior of the roller and rigidly fastened to the roller shell 1 by means of rigid spacers 17; it is preferably shrunk in.

Lastly, FIG. 8 shows a cross-section of a roller in an eighth example embodiment which differs from the roller in the seventh example embodiment only in that both the cylindrical body 16 and the annular gap remaining between the roller shell 1 and the cylindrical body 16 are each completely filled with the mixture 4. Instead of filling the same mixture 4 into each of the two hollow spaces, i.e. into the interior of the cylindrical body 16 and into the annular gap, the two hollow spaces can also be completely or partially filled with mixtures which differ from each other but which each correspond to the mixture 4 in terms of their type.

One or more equalizing chambers can be provided in the hollow spaces, filled with the mixture 4, of all the example embodiments, for example at least one chamber 5 and/or at least one chamber 7.

In the foregoing description, preferred embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A web-processing roller, comprising a roller body having at least one hollow space defined therein, wherein the hollow space is at least partially filled with a mixture consisting of a liquid and at least one insoluble co-ingredient in the liquid, formed by solid particles or by another liquid.

2. The web-processing roller according to claim 1, wherein the mixture exhibits a pulpy consistency.

3. The web-processing roller according to claim 1, wherein the mixture is under a pressure burden.

4. The web-processing roller according to claim 1, wherein the mixture is under a partial vacuum.

5. The web-processing roller according to claim 3, wherein a fluid conduit leads into the hollow space and the mixture can be charged with the pressure burden via the fluid conduit.

6. The web-processing roller according to claim 1, wherein at least one chamber which is variable in its volume is arranged in the hollow space.

7. The web-processing roller according to claim 6, wherein the chamber comprises a flexible chamber wall.

8. The web-processing roller according to claim 6, wherein the chamber is a bubble.

9. The web-processing roller according to claim 6, wherein the chamber comprises a moving chamber wall.

10. The web-processing roller according to claim 9, wherein the chamber wall is mounted, such that it can move, by another chamber wall.

11. The web-processing roller according to claim 6, wherein the chamber is formed by elastic bellows.

12. The web-processing roller according to claim 1, wherein a rotational axis of the roller extends through the mixture in the hollow space.

13. The web-processing roller according to claim 1, wherein the hollow space is rotationally symmetrical with respect to a rotational axis of the roller or is one hollow space of a number of hollow spaces which together form a rotationally symmetrical arrangement of hollow spaces with respect to the rotational axis.

14. The web-processing roller according to claim 1, wherein the roller comprises a roller shell which forms a container wall for the mixture.

15. The web-processing roller according to claim 1, wherein the roller includes a roller shell and a cylindrical body surrounded by the roller shell, and wherein the mixture is arranged between the roller shell and the cylindrical body.

16. The web-processing roller according to claim 1, wherein the roller includes a roller shell and a cylindrical body surrounded by the roller shell, and wherein the mixture is arranged within the cylindrical body.

17. The web-processing roller according to claim 15, wherein the cylindrical body forms a container wall for the mixture.

18. The web-processing roller according to claim 1, wherein the roller comprises a roller shell and a cylindrical body surrounded by the roller shell, and wherein the mixture is arranged between the roller shell and the cylindrical body and another mixture consisting of a liquid and at least one insoluble co-ingredient in the liquid is arranged within the cylindrical body.

19. The web-processing roller according to claim 15, wherein the roller is a displacement-type roller and a displacement body forms the cylindrical body.

20. The web-processing roller according to claim 1, wherein at least one container forming the hollow space is arranged in the roller.

21. The web-processing roller according to claim 1, wherein at least one thermal treatment channel for conducting a heating or cooling fluid extends through the roller body of the roller and ports at at least one axial end of the roller body.

22. The web-processing roller according to claim 1, wherein at least one thermal treatment channel for conducting a heating or cooling fluid extends through the roller body of the roller and ports at both axial ends of the roller body.

23. The web-processing roller according to claim 1, wherein the solid particles are a granular solid.

24. The web-processing roller according to claim 4, wherein a fluid conduit leads into the hollow space and the mixture can be charged with the partial vacuum via the fluid conduit.

25. The web-processing roller according to claim 9, wherein the chamber wall is guided, such that it can move, by another chamber wall.
